(19) United States
(12) Patent Application Publication
(10) Pub. No.: US 2022/0111435 A1
(43) Pub. Date: Apr. 14, 2022

(54) SYSTEMS AND METHODS FOR MELTING METALS PRIOR TO A CASTING PROCESS

(71) Applicant: Lincoln Global, Inc., Santa Fe Springs, CA (US)

(72) Inventors: Robert E. Ewing, Columbus, OH (US); Samuel P. Crescenze, Westerville, OH (US)

(21) Appl. No.: 17/239,979

(22) Filed: Apr. 26, 2021

Related U.S. Application Data
(60) Provisional application No. 63/089,060, filed on Oct. 8, 2020.

(51) Int. Cl. B22D 35/06; B23K 9/04; B22D 39/00

(52) U.S. Cl. CPC B22D 35/06; B23K 9/1675; B22D 39/003; B23K 9/04

(57) ABSTRACT

A system for melting metals for casting includes one or more arc welding power supplies configured to provide one or more arc welding outputs, and one or more electrodes operatively connected to the one or more arc welding outputs. A solid metal holder is configured to hold a solid metal to be melted by one or more arcs formed between the one or more electrodes and the solid metal to generate a molten metal. A container is positioned proximate the solid metal holder to receive the molten metal. A robot is proximate both the container and a mold and/or a die cast machine. The robot has an arm configured to manipulate the container containing the molten metal and pour the molten metal from the container into the mold and/or the die cast machine for casting.

### CROSS REFERENCE TO RELATED APPLICATIONS/INCORPORATION BY REFERENCE

This U.S. patent application claims priority to and the benefit of U.S. Provisional Patent Application Ser. No. 63/089,060 filed on Oct. 8, 2020, which is incorporated herein by reference in its entirety.

### FIELD

Embodiments of the present invention relate to the casting of metals. More specifically, embodiments of the present invention relate to systems and methods for melting metals prior to a casting process.

### BACKGROUND

Metals that are to be cast are typically melted using gas fired furnaces. Current processes used within the casting industry are inefficient from an energy standpoint, are capital intensive, are susceptible to contamination, present the potential for a safety hazard, and incur high setup and changeover costs.

### SUMMARY

A power supply, or multiple power supplies, provide an arc or multiple arcs to a piece of metal. The arc(s) melt the piece of metal (ferrous or non-ferrous). The molten metal is then transferred to a casting process.

One embodiment of the present invention is a system for melting metals for casting. The system includes at least one arc welding power supply configured to provide at least one arc welding output, and at least one electrode operatively connected to the at least one arc welding output. In one embodiment, the electrode is a non-consumable electrode (e.g., a tungsten electrode). In another embodiment, the electrode is a consumable electrode (e.g., also having a fluxing agent in one embodiment). A solid metal holder is configured to hold a solid metal to be melted by at least one arc formed between the at least one electrode and the solid metal to generate a molten metal. A container is positioned proximate the solid metal holder to receive the molten metal. A robot is proximate both the container and a mold and/or a die cast machine. The robot has an arm configured to manipulate the container containing the molten metal and pour the molten metal from the container into the mold or the die cast machine for casting. The molten metal is protected from contamination by at least one of a shielding gas, a vacuum, or a fluxing agent. The at least one arc welding power supply and the robot are configured to control the mass of the molten metal generated and delivered to the mold or die cast machine, in accordance with one embodiment. The at least one arc welding power supply includes at least two arc welding power supplies electrically configured in parallel to provide the at least one arc welding output, in one embodiment. The solid metal holder is configured as at least one of a gripping mechanism, a clamping mechanism, a magnetic mechanism, or a framing mechanism. In one embodiment, the robot includes a programmable controller, where the programmable controller of the robot is programmed to control a rate at which the molten metal is poured into the mold or the die cast machine.

Another embodiment of the present invention is a system for melting metals for casting. The system includes at least one arc welding power supply configured to provide at least one arc welding output, and at least one electrode operatively connected to the at least one arc welding output. In one embodiment, the electrode is a non-consumable electrode (e.g., a tungsten electrode). In another embodiment, the electrode is a consumable electrode (e.g., having a fluxing agent in one embodiment). A solid metal holder is configured to hold a solid metal to be melted by at least one arc formed between the at least one electrode and the solid metal to generate a molten metal. An intermediate vessel is configured to be positioned between the solid metal holder and a mold and/or a die cast machine, providing a pathway for the molten metal to travel from the solid metal holder and into the mold or the die cast machine for casting. In one embodiment, the mold or die cast machine includes a shot sleeve having an elongated tube with a hole and a plunger mechanism. The molten metal is protected from contamination by at least one of a shielding gas, a vacuum, or a fluxing agent. In one embodiment, the at least one arc welding power supply includes at least two arc welding power supplies electrically configured in parallel to provide the at least one arc welding output. The solid metal holder is configured as at least one of a gripping mechanism, a clamping mechanism, a magnetic mechanism, or a framing mechanism. In one embodiment, the intermediate vessel includes an actuator and a plug, wherein the actuator is configured to move the plug to block/release the molten metal into the mold or die cast machine. In one embodiment, the intermediate vessel includes a secondary heating coil configured to induce electrical current into the molten metal while the molten metal is in the intermediate vessel to maintain a relatively constant temperature of the molten metal and/or to stir the molten metal. In one embodiment, the intermediate vessel includes an inert gas inlet configured to accept an inert gas to protect the molten metal from absorbing contaminates from the surrounding air.

Embodiments of the present invention provide reduced power consumption, reduced environmental impact (e.g., reduction of greenhouse gases), quicker setup and changeover, lower contamination, a safer work environment, reduced floor space, and greater process control over that of conventional processes.

Numerous aspects of the general inventive concepts will become readily apparent from the following detailed description of exemplary embodiments, from the claims, and from the accompanying drawings.

### BRIEF DESCRIPTION OF THE DRAWINGS

The accompanying drawings, which are incorporated in and constitute a part of the specification, illustrate various embodiments of the disclosure. It will be appreciated that the illustrated element boundaries (e.g., boxes, groups of boxes, or other shapes) in the figures represent one embodiment of boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1A and FIG. 1B illustrate one embodiment of a system for melting metals for casting;

FIG. 2 illustrates another embodiment of a system for melting metals for casting; and

FIG. 3 illustrates a block diagram of an example embodiment of a controller that can be used, for example, in the system of FIG. 1A and FIG. 1B.

### DETAILED DESCRIPTION

Embodiments of the present invention may include a power supply (or power supplies) that provide electric current sufficient to melt a metal. The raw un-melted metal(s) may be fed into an arc zone using a robot, an automated system, or manually. The delivery and weight monitoring of the raw metal is determined by the amount of molten metal (e.g., aluminum) needed for the part(s) to be cast, and by casting cycle time. The molten metal may be protected from contamination during any point of the process or at multiple points via a shielding gas, a vacuum, a fluxing agent, or any combination thereof. The mass of molten metal is controlled and delivered to the desired casting process.

As an example, inverter-based welding power supplies may be used to melt aluminum ingots of between 0.5 and 50 lbs. Inverter-based welding power supplies are well known in the art. The aluminum is to be melted before being poured into a casting machine or mold. A non-consumable electrode may be employed to melt the metal. Alternatively, a consumable electrode with, for example, a fluxing agent may be used to provide beneficial grain structures, reduced dross, and improved melting. In accordance with one embodiment, 25 lbs. of aluminum can be melted in about 50 seconds. In one embodiment, the process is fully automated.

Cold ingots of metal may be stored and transported, instead of molten metal, to the die cast machine. A cast-able amount of the metal is melted, as needed, at the die cast machine. There is no central stack melter. Alloys may be changed quickly and there is zero energy usage when not making parts. In one embodiment, the composition of the metal is analyzed before melting, the melt temperature is controlled, and contamination is limited.

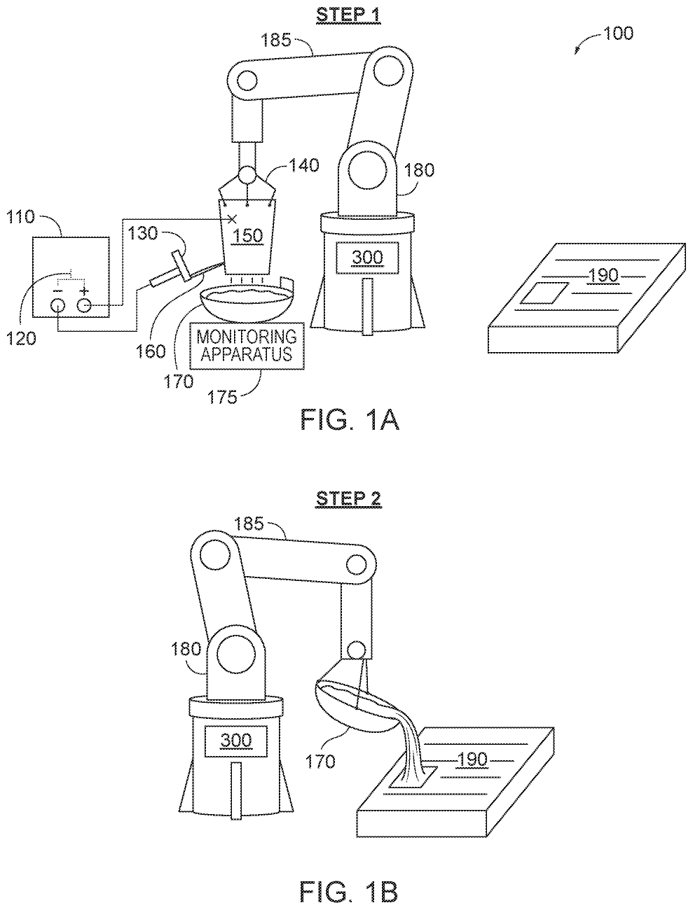

The examples and figures herein are illustrative only and are not meant to limit the subject invention, which is measured by the scope and spirit of the claims. Referring now to the drawings, wherein the showings are for the purpose of illustrating exemplary embodiments of the subject invention only and not for the purpose of limiting same, FIG. 1A and FIG. 1B illustrate an embodiment of a system 100 for melting metals for casting.

Referring to FIG. 1A, the system 100 includes an arc welding power supply 110 configured to provide an arc welding output 120, and a non-consumable electrode 130 operatively connected to the arc welding output 120. In accordance with one embodiment, the arc welding power supply 110 may actually be two or more arc welding power supplies electrically configured in parallel to provide an arc welding output 120 that supplies a higher level of electrical current for melting metal. A solid metal holder 140 is configured to hold a solid metal 150 to be melted by an arc 160 (e.g., a TIG arc) formed between the non-consumable electrode 130 and the solid metal 150 to generate a molten metal (STEP 1 shown in FIG. 1A). In one embodiment, multiple arcs may be formed and used to melt the solid metal 150. For example, multiple welding power supplies 110, each providing a welding output, may be configured with multiple electrodes 130 to melt the solid metal 150 from multiple sides. Alternatively, a single welding power supply can be configured to provide multiple welding outputs supporting multiple electrodes 130. This can result in speeding up the process of melting the solid metal 150.

Note that the solid metal holder 140 is not necessarily made of solid metal itself, but is configured to hold the solid metal 150. The term “solid metal” is used broadly herein and may refer to a billet, an ingot, a bloom, a blank, a slug, or some other form of stock metal. The solid metal holder 140 may be in the form of a gripping mechanism (to grip the solid metal), in accordance with one embodiment. Other types of solid metal holders are possible as well in accordance with other embodiments such as, for example, a clamping mechanism, a magnetic mechanism, or a framing mechanism (e.g., a metal frame configured to hold a billet of a particular size and shape).

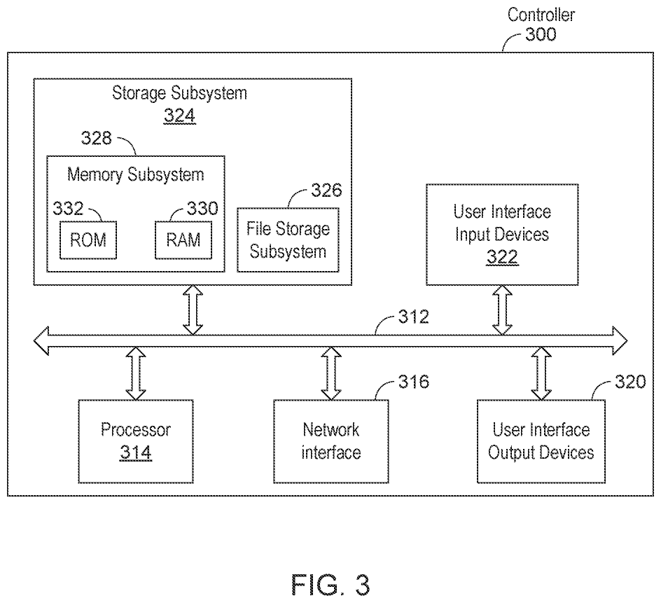

Continuing to refer to FIG. 1A and also FIG. 1B, a container or cup 170 is positioned proximate the solid metal holder 140 to receive the molten metal. A robot 180 is proximate both the container 170 and a mold and/or a die cast machine 190. The robot 180 has an arm 185 configured to position the solid metal holder 140 holding the solid metal 150 and subsequently manipulate the container 170 containing the molten metal and pour the molten metal from the container 170 into the mold or the die cast machine 190 for casting (STEP 2 of FIG. 1B). The robot 180 includes a controller 300 for controlling various aspects of the robot 180, including movement of the arm 185. For example, delivery of the molten metal to the desired casting process by the robot 180 is controlled by the robot controller 300. Furthermore, the robot 180 may be programmed (via the controller 300) to control the rate at which the molten metal is poured into the mold or the die cast machine 190. An embodiment of the controller 300 is discussed herein with respect to FIG. 3.

In one embodiment, a metal monitoring apparatus 175 monitors the amount of the molten metal in the container 170. The metal monitoring apparatus 175 may include, for example, a scale to monitor the weight of the molten metal. In another embodiment, the metal monitoring apparatus 175 may include a laser-based subsystem to monitor a height of the molten metal in the container 170. Other monitoring technologies are possible as well, in accordance with other embodiments. The monitored parameter (e.g., weight or height) is fed back as a signal or as data to the welding power supply 110 and/or to the robot controller 300 such that the amount of molten metal deposited into the container 170 can be controlled.

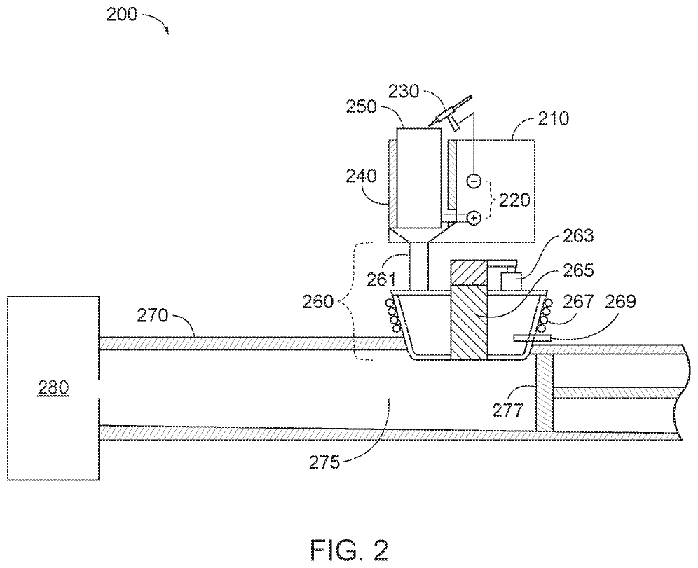

FIG. 2 illustrates another embodiment of a system 200 for melting metals for casting. The system 200 includes an arc welding power supply 210 configured to provide an arc welding output 220, and a non-consumable electrode 230 operatively connected to the arc welding output 220. In accordance with one embodiment, the arc welding power supply 210 may actually be two or more arc welding power supplies electrically configured in parallel to provide an arc welding output 220 that supplies more electrical current for melting metal. A solid metal holder 240 is configured to hold a solid metal 250 to be melted by an arc (the primary means of melting) formed between the non-consumable electrode 230 and the solid metal 250 to generate a molten metal. Again, in one embodiment, multiple arcs may be formed (e.g., using multiple welding power supplies and multiple electrodes) and used to melt the solid metal 250. Alternatively, a single welding power supply can be configured to provide multiple welding outputs supporting multiple electrodes 230. This can result in speeding up the process of melting the solid metal 250.

Continuing to refer to FIG. 2, an intermediate vessel 260 is configured to be positioned between the solid metal holder 240 and a mold and/or a die cast machine 270, providing a pathway 261 for the molten metal to travel from the solid metal holder 240 and into the mold or the die cast machine 270 for casting. The intermediate vessel 260 includes an actuator 263, a plug 265, a secondary coil 267 (providing a secondary means of heating), and an inert gas inlet 269. The die cast machine 270 includes a shot sleeve 275. The actuator 263 is configured to move the plug 265 (e.g., up and down) to block/release metal into the shot sleeve 275. The plug 265 works in conjunction with the actuator 263 and prevents molten metal (e.g., aluminum) from flowing into the shot sleeve 275 of the die cast machine 270 before the die cast machine 270 is ready to receive the molten metal. The die cast machine 270 has a short time window for when the molten metal can be accepted, and the molten metal is held in the intermediate vessel 260 until the die cast machine 270 is ready. In accordance with one embodiment, the actuator 263 is a programmably controlled electro-mechanical device configured to perform the functionality described herein for the actuator 263. Other types of actuators are possible as well (e.g., a manually controlled actuator).

The secondary coil 267 acts to induce electrical current into the molten metal while the molten metal is in a holding chamber of the intermediate vessel 260. This is because the temperature of the molten metal could decrease while it is in the holding chamber. The secondary coil 267 is configured to raise the temperature of the molten metal (to maintain a relatively constant temperature). In one embodiment, the induced electrical current provided by the secondary coil 267 also acts to physically stir the molten metal. Therefore, the secondary coil 267 is used to help stabilize the molten metal, but may or may not be used for each casting cycle. In one embodiment, the secondary coil 267 is electrically powered by the welding power supply 210, providing an alternating current. In another embodiment, the secondary coil 267 is electrically powered by a separate alternating current power supply (not shown).

The shot sleeve 275 is, in one embodiment, an elongated tube with a small hole and a plunger mechanism 277. The molten metal is poured into the shot sleeve 275 from the intermediate vessel 260, and the plunger mechanism 277 pushes the molten metal into a mold 280. The plunger mechanism 277 may be manually controlled or automatically controlled, in accordance with various embodiments. For example, in one embodiment, an operator activates an actuator of the plunger mechanism 277. In another embodiment, a controller activates an actuator of the plunger mechanism 277. The inert gas inlet 269 is configured to accept an inert gas (e.g., argon), from a source of inert gas, to protect the molten metal from absorbing contaminates from the air. For example, the inert gas prevents oxygen, nitrogen, and other contaminates from absorbing into the molten metal.

FIG. 3 illustrates a block diagram of an example embodiment of the controller 300 that is used in the system 100 of FIG. 1A and FIG. 1B, in accordance with one embodiment of the system 100. In accordance with certain embodiments, the welding power supply 110 of FIG. 1A and the welding power supply 210 of FIG. 2 may include such a controller 300 as well. Referring to FIG. 3, the controller 300 includes at least one processor 314 (e.g., a microprocessor, a central processing unit, a graphics processing unit) which communicates with a number of peripheral devices via bus subsystem 312. These peripheral devices may include a storage subsystem 324, including, for example, a memory subsystem 328 and a file storage subsystem 326, user interface input devices 322, user interface output devices 320, and a network interface subsystem 316. The input and output devices allow user interaction with the controller 300. Network interface subsystem 316 provides an interface to outside networks and is coupled to corresponding interface devices in other devices.

User interface input devices 322 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into the controller 300 or onto a communication network.

User interface output devices 320 may include a display subsystem, a printer, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the controller 300 to the user or to another machine or computer system.

Storage subsystem 324 stores programming and data constructs that provide some or all of the functionality described herein. For example, computer-executable instructions and data are generally executed by processor 314 alone or in combination with other processors. Memory 328 used in the storage subsystem 324 can include a number of memories including a main random access memory (RAM) 330 for storage of instructions and data during program execution and a read only memory (ROM) 332 in which fixed instructions are stored. A file storage subsystem 326 can provide persistent storage for program and data files, and may include a hard disk drive, a solid state drive, a floppy disk drive along with associated removable media, a CD-ROM drive, an optical drive, or removable media cartridges. The computer-executable instructions and data implementing the functionality of certain embodiments may be stored by file storage subsystem 326 in the storage subsystem 324, or in other machines accessible by the processor(s) 314.

Bus subsystem 312 provides a mechanism for letting the various components and subsystems of the controller 300 communicate with each other as intended. Although bus subsystem 312 is shown schematically as a single bus, alternative embodiments of the bus subsystem may use multiple buses.

The controller 300 can be of varying types. Due to the ever-changing nature of computing devices and networks, the description of the controller 300 depicted in FIG. 3 is intended only as a specific example for purposes of illustrating some embodiments. Many other configurations of a controller are possible, having more or fewer components than the controller 300 depicted in FIG. 3.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or illustrative examples shown and described. Thus, this disclosure is intended to embrace alterations, modifications, and variations that fall within the scope of the appended claims, which satisfy the statutory subject matter requirements of 35 U.S.C. § 101. The above description of specific embodiments has been given by way of example. From the disclosure given, those skilled in the art will not only understand the general inventive concepts and attendant advantages, but will also find apparent various changes and modifications to the structures and methods disclosed. It is sought, therefore, to cover all such changes and modifications as fall within the spirit and scope of the general inventive concepts, as defined by the appended claims, and equivalents thereof.

What is claimed is:

1. A system for melting metals for casting, the system comprising:
at least one arc welding power supply configured to provide at least one arc welding output;
at least one electrode operatively connected to the at least one arc welding output;
a solid metal holder configured to hold a solid metal to be melted by at least one arc formed between the at least one electrode and the solid metal to generate a molten metal;
a container positioned proximate the solid metal holder to receive the molten metal; and
a robot proximate both the container and a mold or die cast machine, the robot having an arm configured to manipulate the container containing the molten metal and pour the molten metal from the container into the mold or die cast machine for casting.

2. The system of claim 1, wherein the at least one electrode is a non-consumable electrode.

3. The system of claim 1, wherein the at least one electrode is a consumable electrode.

4. The system of claim 1, wherein the molten metal is protected from contamination via at least one of a shielding gas, a vacuum, or a fluxing agent.

5. The system of claim 1, wherein the at least one arc welding power supply and the robot are configured to control the mass of the molten metal generated and delivered to the mold or die cast machine.

6. The system of claim 1, wherein the at least one arc welding power supply includes at least two arc welding power supplies electrically configured in parallel to provide the at least one arc welding output.

7. The system of claim 1, wherein the solid metal holder is configured as at least one of a gripping mechanism, a clamping mechanism, a magnetic mechanism, or a framing mechanism.

8. The system of claim 1, wherein the robot includes a programmable controller.

9. The system of claim 8, wherein the programmable controller of the robot is programmed to control a rate at which the molten metal is poured into the mold or the die cast machine.

10. A system for melting metals for casting, the system comprising:
at least one arc welding power supply configured to provide at least one arc welding output;
at least one electrode operatively connected to the at least one arc welding output;
a solid metal holder configured to hold a solid metal to be melted by at least one arc formed between the at least one electrode and the solid metal to generate a molten metal; and
an intermediate vessel configured to be positioned between the solid metal holder and a mold or die cast machine, providing a pathway for the molten metal to travel from the solid metal holder and into the mold or die cast machine for casting.

11. The system of claim 10, wherein the at least one electrode is a non-consumable electrode.

12. The system of claim 10, wherein the at least one electrode is a consumable electrode.

13. The system of claim 10, wherein the molten metal is protected from contamination via at least one of a shielding gas, a vacuum, or a fluxing agent.

14. The system of claim 10, wherein the at least one arc welding power supply includes at least two arc welding power supplies electrically configured in parallel to provide the at least one arc welding output.

15. The system of claim 10, wherein the solid metal holder is configured as at least one of a gripping mechanism, a clamping mechanism, a magnetic mechanism, or a framing mechanism.

16. The system of claim 10, wherein the intermediate vessel includes an actuator and a plug, wherein the actuator is configured to move the plug to block/release the molten metal into the mold or die cast machine.

17. The system of claim 10, wherein the intermediate vessel includes a secondary heating coil configured to induce electrical current into the molten metal while the molten metal is in the intermediate vessel at least to maintain a relatively constant temperature of the molten metal.

18. The system of claim 10, wherein the intermediate vessel includes an inert gas inlet configured to accept an inert gas to protect the molten metal from absorbing contaminates from surrounding air.

19. The system of claim 10, further comprising a mold or die cast machine.

20. The system of claim 19, wherein the mold or die cast machine includes a shot sleeve having an elongated tube with a hole and a plunger mechanism.
